(19) United States
(12) Patent Application Publication
(10) Pub. No.: US 2025/0174764 A1
(43) Pub. Date: May 29, 2025

(54) THERMAL MANAGEMENT SYSTEM FOR RECHARGEABLE ENERGY STORAGE SYSTEM

(71) Applicant: GM Global Technology Operations LLC, Detroit, MI (US)

(72) Inventors: Ryan Patrick Hickey, Austin, TX (US); Andrew P. Oury, Troy, MI (US); Amrita R. Wadhwa, Troy, MI (US); Galen E. Ressler, White Lake, MI (US)

(21) Appl. No.: 18/519,214

(22) Filed: Nov. 27, 2023

(51) Int. Cl. H01M 10/6567; H01M 10/613; H01M 10/625; H01M 10/63; H01M 10/6556

(52) U.S. Cl. CPC H01M 10/6567; H01M 10/613; H01M 10/625; H01M 10/63; H01M 10/6556; H01M 2220/20

(57) ABSTRACT

A battery system includes a first rechargeable energy storage system (RESS) including a first housing, a second RESS including a second housing, and a thermal management system fluidically connected to the first RESS and the second RESS. The thermal management system includes a source of thermal management fluid, an inlet manifold including a thermal management fluid inlet fluidically connected to the source of thermal management fluid, and an outlet manifold including a thermal management fluid outlet fluidically connected to the thermal management fluid inlet manifold. A first thermal management fluid supply conduit extends through the first RESS and includes a first end connected to the inlet manifold and a second end connected to the first housing. A second thermal management fluid supply conduit extends through the second RESS and includes a first end portion connected to the inlet manifold and a second end portion connected to the second housing.

### INTRODUCTION

The subject disclosure relates to the art of rechargeable energy storage systems and, more particularly, to a thermal management system for a rechargeable energy storage system.

Battery assemblies are formed from a plurality of battery cells arranged in a battery pack. Battery cells include stacks of electrodes arranged in a housing. The battery cells are charged by an external system and discharged into a load. A variety of factors, such as manufacturing defects or cycling (e.g., charging and discharging) the battery beyond design constraints/capabilities, can result in a thermal runaway condition that may affect an entire battery assembly. Various efforts exist for cooling battery systems. Current systems may require that a connection be made to an external cooling medium. Rapidly reducing battery pack temperatures may prevent or stop the thermal runaway condition. Accordingly, it is desirable to provide a system for rapidly lowering battery cell temperatures in order to prevent and/or stop a thermal runaway.

### SUMMARY

A battery system, in accordance with a non-limiting example, includes a first rechargeable energy storage system (RESS) including a first housing, a second RESS including a second housing, and a thermal management system fluidically connected to the first RESS and the second RESS. The thermal management system includes a source of thermal management fluid, an inlet manifold including a thermal management fluid inlet fluidically connected to the source of thermal management fluid, and an outlet manifold including a thermal management fluid outlet fluidically connected to the thermal management fluid inlet manifold. A first thermal management fluid supply conduit extends through the first RESS. The first thermal management fluid supply conduit includes a first end connected to the inlet manifold and a second end connected to the first housing. A second thermal management fluid supply conduit extends through the second RESS. The second thermal management fluid supply conduit includes a first end portion connected to the inlet manifold and a second end portion connected to the second housing.

In addition to one or more of the features described herein, a first inlet valve is arranged in the first thermal management fluid supply conduit, the first inlet valve selectively creating a first passage that fluidically connects the inlet manifold with the outlet manifold through the first RESS.

In addition to one or more of the features described herein, a first outlet valve is arranged in the first thermal management fluid supply conduit at the outlet manifold.

In addition to one or more of the features described herein, the first inlet valve is a normally closed valve, and the first outlet valve is a normally open valve.

In addition to one or more of the features described herein, a second inlet valve is arranged in the second thermal management fluid supply conduit, the second inlet valve selectively creating a second passage that fluidically connects the inlet manifold with the outlet manifold through the second RESS.

In addition to one or more of the features described herein, a second outlet valve is arranged in the second thermal management fluid supply conduit at the outlet manifold.

In addition to one or more of the features described herein, the second inlet valve is a normally closed valve, and the second outlet valve is a normally open valve.

In addition to one or more of the features described herein, a first sensor is mounted in the first RESS and a second sensor is mounted in the second RESS.

In addition to one or more of the features described herein, a control system is operatively connected to the first sensor, the second sensor, the first inlet valve, and the second inlet valve, the control system selectively opening the first inlet valve and the second inlet valve based on a triggering parameter sensed in the first RESS and the second RESS respectively.

In addition to one or more of the features described herein, the source of thermal management fluid comprises a container of thermal management fluid.

In addition to one or more of the features described herein, the container of thermal management fluid comprises a container of water.

In addition to one or more of the features described herein, the source of thermal management fluid comprises a body of water.

In addition to one or more of the features described herein, the body of water comprises one of a body of fresh water and a body of salt water.

In addition to one or more of the features described herein, the source of thermal management fluid comprises a water utility.

A method of managing temperatures in a battery system, in accordance with a non-limiting example, includes sensing a first internal temperature in a first rechargeable energy storage system (RESS), sensing a second internal temperature in a second (RESS), detecting a triggering parameter in the first RESS, opening a valve fluidically connecting the first RESS with a source of thermal management fluid, and passing a thermal management fluid from the source of thermal management fluid through a first thermal management fluid supply conduit connected to the source of thermal management fluid and passing through the first RESS.

In addition to one or more of the features described herein, the method further includes closing an outlet valve fluidically connected to a second thermal management fluid supply conduit connected to the source of thermal management fluid and passing through the second RESS before passing the thermal management fluid through the first thermal management fluid supply conduit.

In addition to one or more of the features described herein, the method further includes passing the thermal management fluid from the first RESS to a drain.

In addition to one or more of the features described herein, passing the thermal management fluid to the drain includes passing the thermal management fluid into an outlet manifold fluidically connected to each of the first thermal management fluid supply conduit and the second thermal management fluid supply conduit.

In addition to one or more of the features described herein, passing the thermal management fluid from the source of thermal management fluid through the first thermal management fluid supply conduit includes introducing the thermal management fluid into an inlet manifold fluidically connected to the first thermal management fluid supply conduit and the second thermal management fluid supply conduit.

In addition to one or more of the features described herein, passing the thermal management fluid into the inlet manifold includes drawing water from a body of water into the inlet manifold.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic view of a rechargeable energy storage system (RESS) including a thermal management system, in accordance with a non-limiting example;

FIG. 2 is a schematic view of a control system for the thermal management system, in accordance with a non-limiting example;

FIG. 3 depicts a vessel including a battery system having the thermal management system, in accordance with a non-limiting example; and

FIG. 4 is a perspective view of a locomotive including a battery system having the thermal management system, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

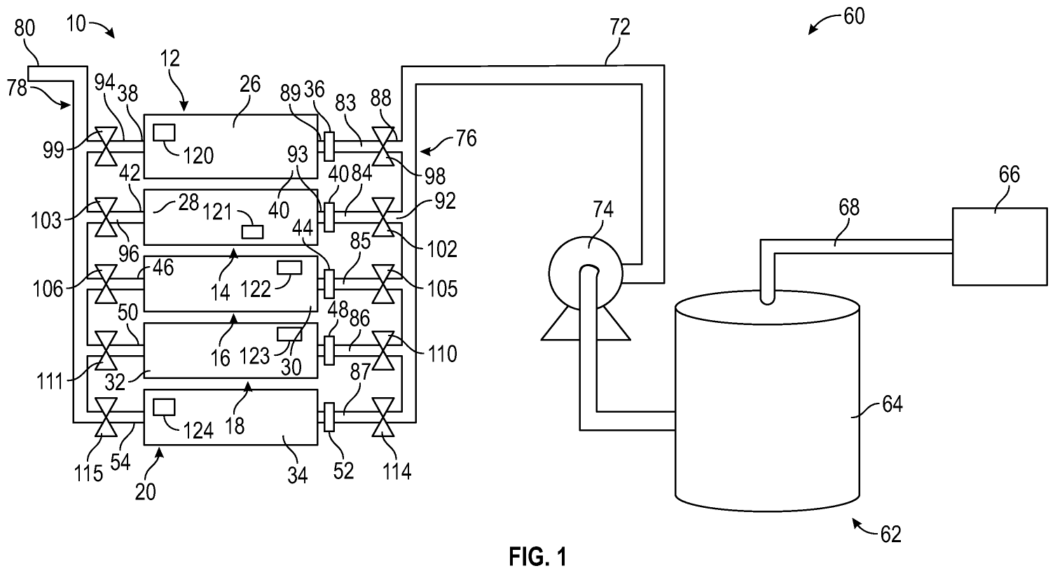

A battery system, in accordance with a non-limiting example, is shown generally at 10 in FIG. 1. Battery system 10 includes a first rechargeable energy storage system (RESS) 12, a second RESS 14, a third RESS 16, a fourth RESS 18, and a fifth RESS 20. The number and arrangement of rechargeable energy storage systems may vary and may depend on energy delivery needs. For example, battery system 10 may provide power to a residential home, a business, a factory or the like. First RESS 12 includes a first housing 26, second RESS 14 includes a second housing 28, third RESS 16 includes a third housing 30, fourth RESS 18 includes a fourth housing 32, and fifth RESS 20 includes a fifth housing 34. While shown as being arranged in separate housings, it should be understood that multiple rechargeable energy storage systems may be integrated into a single housing.

In further accordance with a non-limiting example, first RESS 12 includes a first inlet 36 and a first outlet 38. Second RESS 14 includes a second inlet 40 and a second outlet 42. Third RESS 16 includes a third inlet 44 and a third outlet 46. Fourth RESS 18 includes a fourth inlet 48 and a fourth outlet 50, and fifth RESS 20 includes a fifth inlet 52 and a fifth outlet 54. As will be detailed more fully herein, first inlet 36, second inlet 40, third inlet 44, fourth inlet 48, and fifth inlet 52 provide a pathway for a thermal management fluid to selectively enter and cool any one of the first RESS 12, second RESS 14, third RESS 16, fourth RESS 18, and fifth RESS 20 having battery cells (not shown) that may be experiencing a significant over temperature condition such as, for example, thermal run away.

In a non-limiting example, battery system 10 includes a thermal management system 60 that acts as a source of the thermal management fluid. In one non-limiting example, thermal management system 60 provides a dedicated source of thermal management fluid 62 to battery system 10. The dedicated source of thermal management fluid 62 may reside in a dedicated water storage vessel or container 64 that is directly fluidically connected to, for example, a municipal water supply 66. Container 64 may store a readily available supply of thermal management fluid or water.

While shown as being a container 64, it should be understood that thermal management system 60 may simply represent a direct connection between battery system 10 and the municipal supply 66 without including any intermediate reservoirs. Regardless of how sourced, thermal management system 60 provides a constant source of pressurized thermal management fluid to battery system 10 that can mitigate any over temperature conditions that may occur.

In a non-limiting example, municipal water supply 66 is fluidically connected to container 64 through a supply conduit 68. Container 64 is filled with an amount of thermal management fluid, such as water, and serves as a reservoir in the event municipal water supply 66 has been compromised. A thermal management fluid delivery conduit 72, that may include a pump 74, is connected to battery system 10. More specifically, thermal management system 60 includes an inlet manifold 76 connected to thermal management fluid delivery conduit 72 and each of the first housing 26, the second housing 28, the third housing 30, the fourth housing 32, and the fifth housing 34. Thermal management system 60 also includes an outlet manifold 78 connected to each of the first housing 26, the second housing 28, the third housing 30, the fourth housing 32, the fifth housing 34, and a thermal management fluid outlet leading to a drain 80.

In a non-limiting example, thermal management system 60 includes a first thermal management fluid supply conduit 83 extending through first housing 26 and fluidically connected to inlet manifold 76 and outlet manifold 78. Thermal management system 60 further includes a second thermal management fluid supply conduit 84 extending through second housing 28 and fluidically connected to inlet manifold 76 and outlet manifold 78. A third thermal management fluid supply conduit 85 extends through third housing 30 and fluidically connects to inlet manifold 76 and outlet manifold 78. A fourth thermal management fluid supply conduit 86 extending through fourth housing 32 and fluidically connects to inlet manifold 76 and outlet manifold 78. A fifth thermal management fluid supply conduit 87 extends through fifth housing 34 and fluidically connects to inlet manifold 76 and outlet manifold 78.

In a non-limiting example, first thermal management fluid supply conduit 83 includes a first end 88 fluidically connected to inlet manifold 76 and a second end 89 fluidically connected to first housing 26. Second thermal management fluid supply conduit 84 includes a first end portion 92 fluidically connected to inlet manifold 76 and a second end portion 93 fluidically connected to second housing 28. Third thermal management fluid supply conduit 85, fourth thermal management fluid supply conduit 86, and fifth thermal management fluid supply conduit 87 are similarly formed.

In a non-limiting example, a first thermal fluid management fluid outlet conduit 94 is fluidically connected between first outlet 38 of first housing 26 and outlet manifold 78. A second thermal fluid management fluid outlet conduit 96 is fluidically connected between second outlet 42 of second housing 28 and outlet manifold 78. Third outlet 46, fourth outlet 50, and fifth outlet 54 are likewise connected to outlet manifold 78 through individual thermal fluid management fluid outlet conduits (not separately labeled).

In a non-limiting example, first thermal management fluid supply conduit 83 includes a first inlet valve 98 arranged in first thermal management fluid supply conduit 83 between first end 88 and first housing 26 and a first outlet valve 99 is arranged in first thermal fluid management fluid outlet conduit 90 between first outlet 38 of first housing 26 and second end 93. A second inlet valve 102 is arranged in second thermal management fluid supply conduit 84 between first end portion 92 and second housing 28 and a second outlet valve 103 arranged in second thermal management fluid outlet conduit 96 between second outlet 42 of second housing 28 and outlet manifold 78. First inlet valve 98 selectively establishes a first passage for thermal management fluid to pass into first housing 26. Similarly, second inlet valve 102 selectively creates a second passage for thermal management fluid to pass into second housing 28.

In a similar manner, third thermal management fluid supply conduit 85 supports a third inlet valve 105 and the third thermal fluid management fluid outlet conduit includes a third outlet valve 106, fourth thermal management fluid supply conduit 86 supports a fourth inlet valve 110 and the fourth thermal fluid management fluid outlet conduit includes a fourth outlet valve 111, and fifth thermal management fluid supply conduit 87 supports a fifth inlet valve 114 and the fifth thermal fluid management fluid outlet conduit includes a fifth outlet valve 115. In a non-limiting example, each inlet valves 98, 102, 105, 110, and 114 is a normally closed valve and each outlet valve 99, 103, 106, 111, and 115 is a normally open valve.

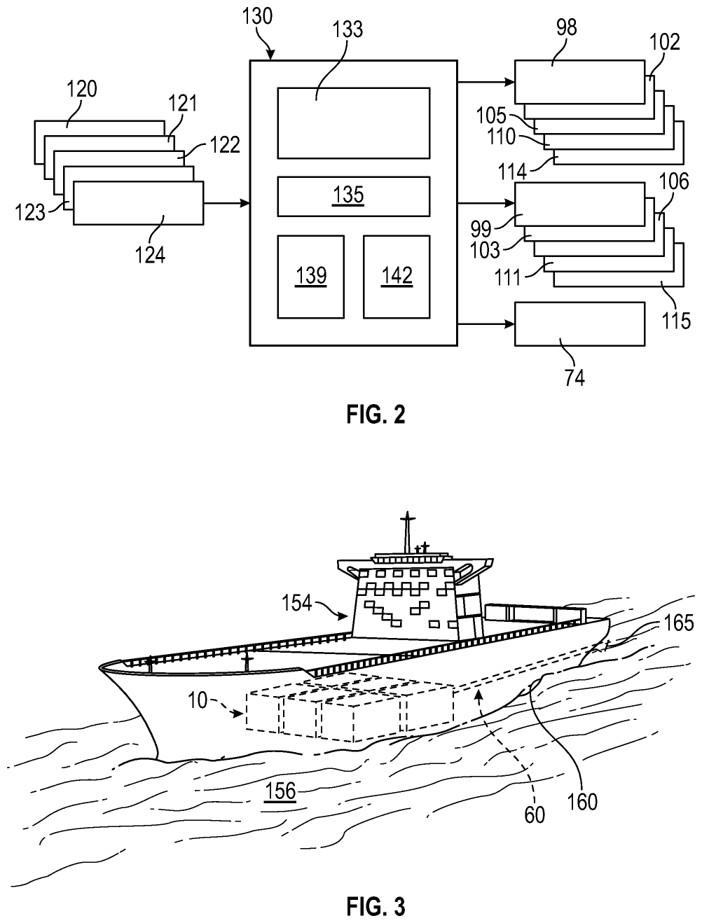

Referring now to FIG. 2 and with continued reference to FIG. 1, a first sensor 120 is arranged in first housing 26, a second sensor 121 is arranged in second housing 28, a third sensor 122 is arranged in third housing 30, a fourth sensor 123 is arranged in fourth housing 32, and a fifth sensor 124 is arranged in fifth housing 34. First sensor 120, second sensor 121, third sensor 122, fourth sensor 123, and fifth sensor 124 are arranged to detect a triggering parameter or an abnormal operating condition of corresponding ones of the first RESS 12, the second RESS 14, the third RESS 16, the fourth RESS 18, and the fifth RESS 20. Triggering parameters may be based on temperature values, voltage values, current values, gas values, pressure values, infra-red values, light values, audio values and/or other appropriate measurements. Triggering values may represent absolute values, rate of change values and/or integrated values. For example, the sensors may detect out of range temperatures, unusual voltages or the like that indicate an abnormal operating condition that may lead to an over temperature condition such as a thermal runway condition.

In a non-limiting example, a control system 130 is connected to battery system 10 and thermal management system 60. Control system 130 includes a central processing unit (CPU) 133, a non-volatile memory 135, a valve control module 139 and a thermal management control module 142. Control system 130 receives inputs from each of the first sensor 120, second sensor 121, third sensor 122, fourth sensor 123, and fifth sensor 124. In a non-limiting example, first sensor 120 provides a first internal temperature value, second sensor 121 provides a second internal temperature value, third sensor 122 provides a third internal temperature value, fourth sensor 124 provides a fourth internal temperature value, and fifth sensor 124 provides a fifth internal temperature value. Thermal management control module 142 evaluates the internal temperature values to determine whether battery system 10 is experiencing a thermal response that exceeds values stored in non-volatile memory 135. If the thermal response is indicative of a potential thermal runaway condition, thermal management control module 142 takes remedial actions.

In a non-limiting example, if thermal management control module 142 detects an out of temperature condition in, for example, first RESS 12, valve control module 139 signals second outlet valve 103, third outlet valve 106, fourth outlet valve 111, and fifth outlet valve 115 to close. In this manner, second housing 28, third housing 30, fourth housing 32, and fifth housing 34 are isolated from outlet manifold 78. At this point, valve control module 139 opens first inlet valve 98 allowing thermal management fluid to flow from inlet manifold 76 through first housing 26 in order to lower temperature and prevent the over temperature condition from a runaway condition. The immediate access to thermal management fluid ensures that the over temperature condition can be mitigated quickly.

In a non-limiting example, second end 89 of first thermal management fluid supply conduit 83 and second end portion 93 of second thermal management fluid supply conduit 84 represent RESS interfaces (not separately labeled) that open, (e.g., such as by rupturing a burst disk, opening a check valve etc.) when thermal management fluid passes through first inlet valve 98 and/or second inlet valve 102. The use of burst disks, check valves and the like ensure that gases that may be generated in, for example, first RESS 12 and/or second RESS 14 to not pass into thermal fluid management system 60 via inlet manifold 76.

Referring to FIG. 3, battery system 10 and thermal management system 60 may be integrated into a vessel such as a boat 154 sitting in a body of water 156. Body of water 156 may be a body of fresh water or a body of salt water. Boat 154 includes a waterline 160. In a non-limiting example, inlet manifold 76 includes an inlet 165 arranged below water line 160. In this manner, in the event an over temperature condition occurs in battery system 10, thermal management control module 142 can operate pump 74 to draw in thermal management fluid directly from body of water 156. The immediate access to thermal management fluid, (e.g., water) ensures that the over temperature condition can be mitigated quickly allowing battery system 10 to continue operating such that boat 154 may seek a nearby port. Fluid flowing into battery system 10 will pass through an outlet so that boat 154 does not take on unnecessary ballast.

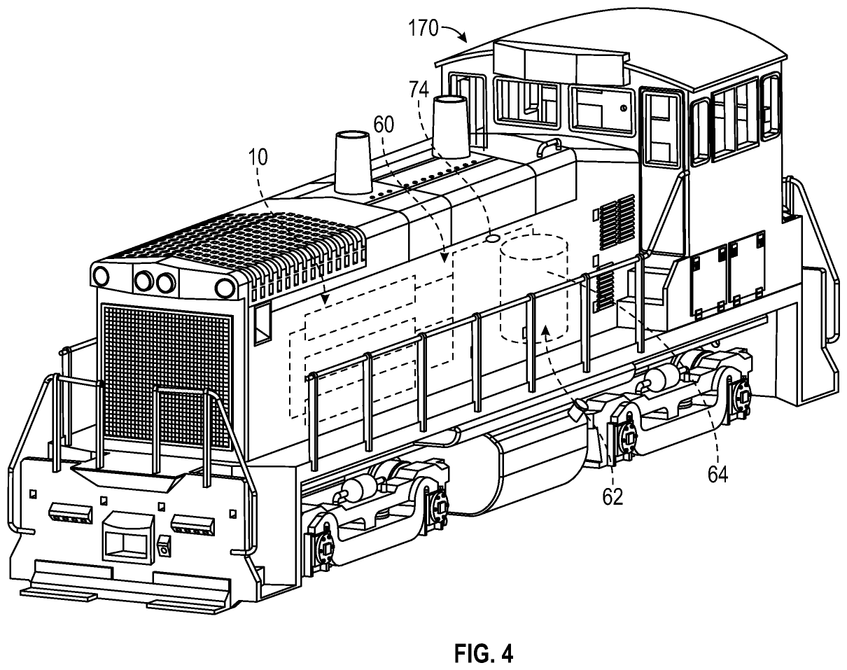

In FIG. 4, battery system 10 and thermal management system 60 may be integrated into a locomotive 170. Locomotive 170 may use battery system 10 as a primary source of power or as a secondary source of power. Regardless of the application, thermal management system 60 includes container 64 storing an amount of thermal management fluid. In this manner, in the event an over temperature condition occurs in battery system 10, thermal management control module 142 can operate pump 74 to draw in thermal management fluid directly from container 64 and pass the ready supply of pressurized thermal management fluid through an affected RESS. The immediate access to thermal management fluid, (e.g., water) ensures that the over temperature condition can be mitigated quickly allowing battery system 10 to continue operating such that locomotive 170 may seek service. In addition to supplying thermal management fluid to battery system 10, outlet manifold may include additional ports (not shown) that emergency service personnel may connect to if desired.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery system comprising:
a first rechargeable energy storage system (RESS) including a first housing;
a second RESS including a second housing; and
a thermal management system fluidically connected to the first RESS and the second RESS, the thermal management system comprising:
a source of thermal management fluid;
an inlet manifold fluidically connected to the source of thermal management fluid;
an outlet manifold including a thermal management fluid outlet fluidically connected to the thermal management fluid inlet manifold;
a first thermal management fluid supply conduit extending through the first RESS, the first thermal management fluid supply conduit including a first end connected to the inlet manifold and a second end connected to the first housing; and
a second thermal management fluid supply conduit extending through the second RESS, the second thermal management fluid supply conduit including a first end portion connected to the inlet manifold and a second end portion connected to the second housing.

2. The battery system according to claim 1, further comprising a first inlet valve arranged in the first thermal management fluid supply conduit, the first inlet valve selectively creating a first passage that fluidically connects the inlet manifold with the outlet manifold through the first RESS.

3. The battery system according to claim 2, further comprising a first outlet valve arranged in the first thermal management fluid supply conduit at the outlet manifold.

4. The battery system according to claim 3, wherein the first inlet valve is a normally closed valve, and the first outlet valve is a normally open valve.

5. The battery system according to claim 3, further comprising a second inlet valve arranged in the second thermal management fluid supply conduit, the second inlet valve selectively creating a second passage that fluidically connects the inlet manifold with the outlet manifold through the second RESS.

6. The battery system according to claim 5, further comprising a second outlet valve arranged in the second thermal management fluid supply conduit at the outlet manifold.

7. The battery system according to claim 6, wherein the second inlet valve is a normally closed valve, and the second outlet valve is a normally open valve.

8. The battery system according to claim 6, further comprising a first sensor mounted in the first RESS and a second sensor mounted in the second RESS.

9. The battery system according to claim 8, further comprising a control system operatively connected to the first sensor, the second sensor, the first inlet valve and the second inlet valve, the control system selectively opening the first inlet valve and the second inlet valve based on a triggering parameter sensed in the first RESS and the second RESS respectively.

10. The battery system according to claim 1, wherein the source of thermal management fluid comprises a container of thermal management fluid.

11. The battery system according to claim 10, wherein the container of thermal management fluid comprises a container of water.

12. The battery system according to claim 1 wherein the source of thermal management fluid comprises a body of water.

13. The battery system according to claim 12, wherein the body of water comprises one of a body of fresh water and a body of salt water.

14. The battery system according to claim 1, wherein the source of thermal management fluid comprises a water utility.

15. A method of managing temperatures in a battery system, the method comprising:
sensing a first internal temperature in a first rechargeable energy storage system (RESS);
sensing a second internal temperature in a second (RESS);
detecting a triggering parameter in the first RESS;
opening a valve fluidically connecting the first RESS with a source of thermal management fluid; and
passing a thermal management fluid from the source of thermal management fluid through a first thermal management fluid supply conduit connected to the source of thermal management fluid and passing through the first RESS.

16. The method of claim 15, further comprising: closing an outlet valve fluidically connected to a second thermal management fluid supply conduit connected to the source of thermal management fluid and passing through the second RESS before passing the thermal management fluid through the first thermal management fluid supply conduit.

17. The method of claim 16, further comprising passing the thermal management fluid from the first RESS to a drain.

18. The method of claim 17, wherein passing the thermal management fluid to the drain includes passing the thermal management fluid into an outlet manifold fluidically connected to each of the first thermal management fluid supply conduit and the second thermal management fluid supply conduit.

19. The method of claim 18, wherein passing the thermal management fluid from the source of thermal management fluid through the first thermal management fluid supply conduit includes introducing the thermal management fluid into an inlet manifold fluidically connected to the first thermal management fluid supply conduit and the second thermal management fluid supply conduit.

20. The method of claim 19, wherein passing the thermal management fluid into the inlet manifold includes drawing water from a body of water into the inlet manifold.
